(19) United States
(12) Patent Application Publication
(10) Pub. No.: US 2021/0056578 A1
(43) Pub. Date: Feb. 25, 2021

(54) METHOD AND SYSTEM FOR PROVIDING AUTOMATED ON-SITE MERCHANT COUPONS

(71) Applicant: RETAILCOMMON INC., TORONTO, ON (CA)

(72) Inventors: QI (NICK) ZHU, TORONTO, ON (CA); JAMES CUNNINGHAM, TORONTO, ON (CA); COLLEY CLARKE, TORONTO, ON (CA)

(21) Appl. No.: 16/959,512

(22) PCT Filed: Jan. 4, 2019
(86) PCT No.: PCT/CA2019/050005

§ 371 Date: Jul. 1, 2020

Related U.S. Application Data
(60) Provisional application No. 62/613,452, filed on Jan. 4, 2018.

(51) Int. Cl. G06Q 30/02; G06Q 30/06

(52) U.S. Cl. CPC G06Q 30/0224; G06Q 30/0629; G06Q 30/0223

(57) ABSTRACT

A method and system for providing automated on-site merchant coupons including determining a product of interest, determining if there is a coupon available for the product of interest and then generating and transmitting the coupon if one is available. The determination of whether a coupon is available may be based on a set of rules as designated by a merchant or may be based on a price-matching criteria.

### CROSS-REFERENCE TO OTHER APPLICATIONS

The current application claims benefit from U.S. Provisional Application No. 62/613,452 filed Jan. 4, 2018, the contents of which are hereby incorporated by reference.

### FIELD

The disclosure is generally directed at the field of electronic commerce and more specifically, at a method and system for providing automated on-site merchant coupons.

### BACKGROUND

Use of the Internet continues to grow at a rapid pace along with the introduction of different enhancements and ways to interact with the Internet. Users can now perform many different functionalities over the Internet. These functions include, but are not limited to, booking vacations, making purchases, marketing products or services, reading the news and checking prices of products.

Currently, when consumers are in a retail or merchant shop, consumers may use the Internet to search for the price of a specific consumer good, or product of interest, being sold by a competitor to determine where they may be able to purchase the consumer good at the lowest price. As such, the merchant that the consumer is located at may lose a potential sale due to the availability of the specific consumer good at another location due to a lower price. Consumers may be able to purchase the consumer good at another bricks and mortar location or may purchase the good from an online shopping site.

Therefore, there is provided a novel method and system for providing automated on-site merchant coupons.

### SUMMARY

The disclosure is directed at a method and system for providing automated on-site merchant coupons. In one embodiment, the system includes a server that communicates with a user, via the user's handheld communication device, as a user is walking through a merchant's storefront, to provide an automated on-site merchant coupon for a product or consumer good of interest.

In one embodiment, as a user browses, or scans, the price of a product of interest within a merchant storefront, the user may determine what the cost of the product is at competing merchants. In response to this determination, the system provides an automated on-site merchant coupon to the user to provide the user incentive to purchase the product of interest at the merchant storefront. In one embodiment, the method and system may generate and transmit an automated on-site price-matching coupon that provides a discount to the user if they purchase the product at the current merchant location. In another embodiment, the coupon provided to the user may match the lowest price that the user can purchase the product within a specific geographic area or via online merchants or any other criteria.

In one aspect of the disclosure, there is provided a method for providing an automated on-site merchant coupon including determining a product of interest; determining if a coupon is available for the product of interest; and generating the automated on-site merchant coupon if a coupon is available for the product of interest.

In another aspect, determining a product of interest includes receiving a search for the product of interest from a user communication device. In a further aspect, determining a product of interest includes determining a user's location within a merchant store based on a location of a user communication device; comparing the user's location with a map of the merchant store; and determining the product of interest based on the user's location. In yet another aspect, determining the product of interest based on the user's location includes determining a department within the merchant store that the user is located based on the map of the merchant store; and determining the product of interest based on the user's location within the department.

In another aspect, determining if a coupon is available includes comparing the product of interest with a list of products; and determining if the product of interest is on the list of products. In an aspect, determining if a coupon is available further includes after determining the product of interest is on the list of products, determining, via a set of predetermined rules, if a coupon is available for the product of interest. In yet a further aspect, determining if a coupon is available comparing a price of the product of interest with prices of competing merchants; determining if at least one of the prices of competing merchants is less than the price of the product of interest; and if at least one of the at least one prices of competing merchants is less than the price of the product of interest, determining a coupon is available.

In yet another aspect, generating the automated on-site coupon includes generating a price-matching coupon based on the lowest of the at least one prices that is lower than the price of the product of interest. In yet another aspect, the method includes transmitting the price-matching coupon as the automated on-site coupon to the user. In yet a further aspect, determining a product of interest includes receiving product of interest information from a user communication device.

In another aspect of the disclosure, there is provided a computer-readable medium having stored thereon computer executable instructions, that, if executed, cause a computer system to determine a product of interest; determine if a coupon is available for the product of interest; and generate the automated on-site merchant coupon if a coupon is available for the product of interest.

In another aspect, determining a product of interest includes receiving product of interest information from a user device. In another aspect, the computer readable medium includes computer readable instructions that, if executed, cause the computer system to: compare the product of interest with a list of products; and determine if the product of interest is on the list of products. In yet another aspect, the computer readable medium further includes computer readable instructions that, if executed, cause the computer system to after determining the product of interest is on the list of products, determine, via a set of predetermined rules, if a deal is available for the product of interest.

In yet a further aspect, the computer readable medium includes computer readable instructions that, if executed, cause the computer system to compare a price of the product of interest with prices of competing merchants; determine if at least one of the prices of competing merchants is less than the price of the product of interest; and if at least one of the prices is less than the price of the product of interest, determine a deal is available. In an aspect, the computer readable medium includes computer readable instructions that, if executed, cause the computer system to generate a coupon for the user. In another aspect, the computer readable medium includes computer readable instructions that, if executed, cause the computer system to generate the coupon based on predetermined rules. In an aspect, the computer readable medium includes computer readable instructions that, if executed, cause the computer system to generate the coupon based on a lower of the at least one of the prices that is less than the price of the product of interest.

### DESCRIPTION OF THE DRAWINGS

Embodiments of the present disclosure will now be described, by way of example only, with reference to the attached Figures.

FIG. 1 is a schematic diagram of a system for providing an on-site merchant coupon;

FIG. 2 is a schematic diagram showing one embodiment of a server for use in the system of FIG. 1;

FIG. 3 is a flowchart outlining an embodiment of a method of providing an on-site merchant coupon and

FIG. 4 is a schematic diagram of an on-site merchant coupon received by a user.

### DETAILED DESCRIPTION OF THE EMBODIMENTS

The disclosure is directed at a system and method for providing at least one automated on-site merchant coupon. In one embodiment, the system includes a server that communicates with users, via a user handheld communication device, as the user is walking around in a merchant's storefront.

When a user stops to look at a specific consumer good or product of interest on the user's handheld communication device, the system may generate an automated on-site merchant coupon for the product of interest in order to entice the user to purchase the product of interest at the merchant store rather than from a competitor. In another embodiment, the system may determine the product of interest based on location information and may push an automated on-site merchant coupon to the user based on the user's location within the store. In this manner, the merchant is able to provide a user with a coupon for a possible product of interest to protect against the user purchasing the same item from a competitor (either at their store or from an online site). In one embodiment, the coupon may be a price-matching coupon. Furthermore, the coupon being provided to the user may be one that is store specific or time-sensitive as well.

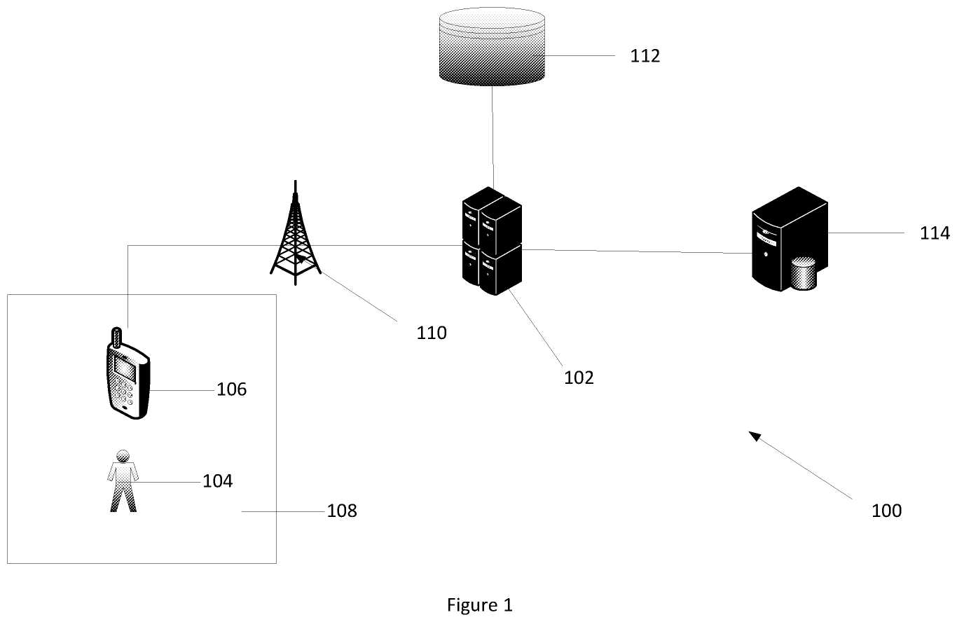

Turning to FIG. 1, a system for providing an automated on-site merchant coupon is shown. In the current embodiment, the system 100 includes a server 102 that communicates with a user 104 via a user communication device 106, which in the current embodiment is shown as a SmartPhone™. It will be understood that the user may use any type of device to communicate with the server 102, such that the server 102 can provide an automated on-site merchant coupon to the user. In one embodiment, the communication device 106 is preferably portable, such as a handheld communication device, whereby the user can bring and use the device 106 while shopping at a merchant storefront 108. In another embodiment, the communication device 106 may be able to scan a barcode associated with a product of interest to retrieve information about the product. Examples of communication devices 106 include, but are not limited to, a Smartphone, a tablet or a personal digital assistant (PDA). Other types of handheld communication devices that are capable of communicating with a server may also be used.

Communication between the server 102 and the communication device 106 is preferably over a wireless communication network, seen as radio towers 110. Wireless communication will be well understood by one skilled in the art. The server 102 may also be connected to a database 112 and/or other servers 114. In one embodiment, the database 112 may store information relating to, but not limited to, rules relating to when merchant coupons should be issued to users, information relating to available coupons for a product, information relating to prices of products at competing merchants and/or information relating to prices of products for a merchant. The database 112 may also store the coupons, or information and/or images that may be used to generate coupons. Although shown separate from the server 102, the database 112 may also be integrated within the server 102.

Examples of the servers 114 may include servers that store product price information of different merchants such that the server 102 may access this information in order to determine if an automated on-site merchant coupon should be issued. Another example of the server 114 may be a server that is associated with a merchant, either the merchant that the user is visiting or a competing merchant.

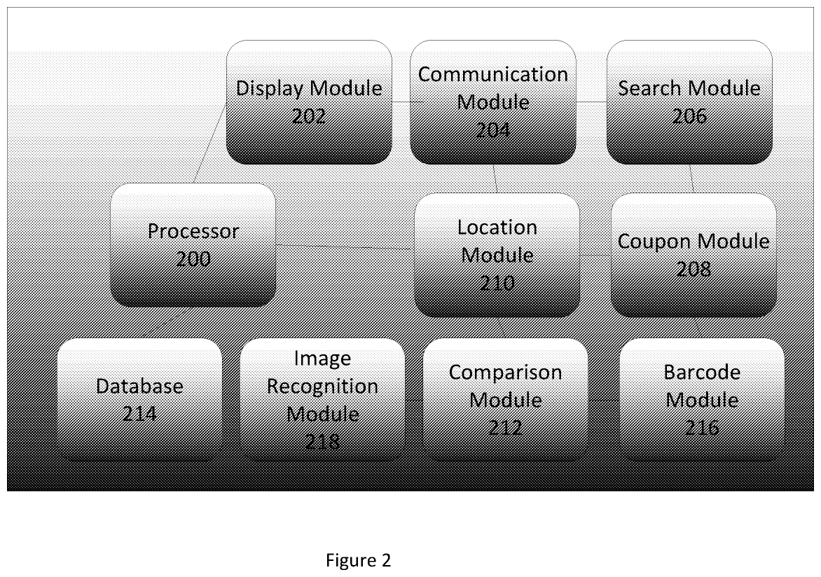

Turning to FIG. 2, a schematic diagram of the server 102 is shown. Although the preferred embodiment is preferably implemented within a single server, it will be understood that the system may be distributed over multiple servers. The server, or servers, 102 preferably include(s) a plurality of modules for communicating with the user and for providing the automated on-site merchant coupon to the user, where necessary. Although connections are not shown between each component within the server for clarity purposes, it will be understood that each of the modules may communicate with each other and with the processor and database and other components external to the server 102.

As shown in FIG. 2, in one embodiment, the server 102 includes a processor 200 that controls a plurality of modules that assist to implement a method and system of providing automated on-site merchant coupons. The plurality of modules may include, but are not limited to, a display module 202, a communication module 204, a search module 206, a coupon module 208, a location module 210, a price comparison module 212 and a barcode module 216. An image recognition module 218 may also be included within the plurality of modules.

A database 214 (which may be the database 112) may also be included within the server 102. Although specific modules are shown and described, these modules may also be integrated into a single module or any number of modules as desired.

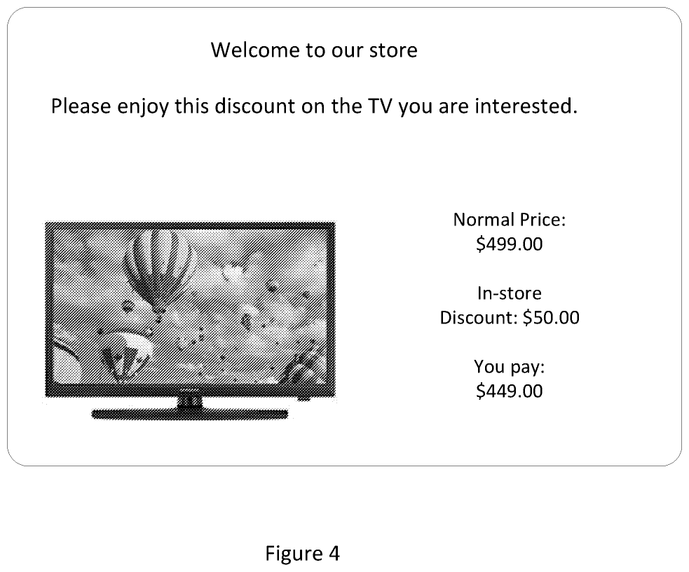

In one embodiment, the display module 202 operates to generate and/or transmit images, or screens, that are displayed on the user communication device. For instance, the display module 202 may create the on-site merchant coupon that the user views on their communication device or may generate a barcode that can be scanned at checkout. One example of an on-site merchant coupon that may be transmitted to the user is schematically shown in FIG. 4. The display module 202 may also perform the necessary actions to convert images into a format that is viewable on the user's particular communication device.

In the current embodiment, the communication module 204 includes the firmware, such as apparatus, components or software, for the server 102 to communicate with the user communication device 106. In a preferred embodiment, the communication is performed wirelessly whereby this wireless communication may be via any known telecommunication networks and therefore, the components with the communication module 204 may be any components that enable this wireless communication between the server and the user communication device 106.

The search module 206 may operate to determine if there is a merchant coupon associated with a product of interest or a product being searched by a user on their user communication device. In one embodiment, the communication module 204 receives the search parameters or search term that were/was entered by the user 104 on the user communication device 106 and transmits them to the search module 206 which then determines if there is an on-site merchant coupon to be issued to the user. In one embodiment, the search module 206 may compare the search term (including an indication of the product of interest) with a list of products (such as stored in the database 214 or the coupon module 208) that may be associated with available merchant coupons to determine if there is a merchant coupon available for the product of interest. Alternatively, as will be described below, the communication module 204 may receive product of interest information from the barcode module 216 that is used by the search module to determine if there is an on-site merchant coupon available for the product of interest.

In one embodiment, the coupon module 208 may store merchant coupons and/or rules designated by a merchant for when an automated on-site merchant coupon should be issued to a user. If the search module 206 determines that a merchant coupon is available, the search module 204 may send a signal to the coupon module 208 to determine the type of coupon to issue and to generate/transmit the merchant coupon to the user (such as via the display module 202 and/or the communication module 204 or any other module). Alternatively, the coupon module 208 may review the rules designated by the merchant to determine the value or type of coupon to generate before generating the coupon or before transmitting signals for the coupon to be generated. Alternatively, the coupon module 208 may generate the coupon or may transmit instructions to the display module to generate the coupon. If the search module 206 determines that there are no available merchant coupons (or that the product of interest was not on the list of products), the search module 206 may communicate with the coupon module 208 to determine if a coupon should be generated based on the rules designated by the merchant. For instance, a rule may be that if there are no coupons available, the system should search for the lowest online (or searched) price and issue a price matching coupon. Alternatively, a rule may be that if there are no coupons available, the system should search for the lowest price for the product of interest within a predetermined geographical area. Alternatively, the system may generate a coupon based on the lower price of both an online and geographical area search. In another embodiment, if there are no coupons available, the system may generate a 10% off coupon. In another embodiment, the system may generate no coupon. In another embodiment, a partner of the merchant may offer a coupon of certain value. For example, a movie theatre in the same shopping mall might decide to participate and offer a coupon for movie tickets

Alternatively, the search module 206 may determine if a coupon should be generated for a user based on product of interest information and rules designated by a merchant for coupon generation. In a further example, the merchant may implement a rule whereby if a user is searching for a television, a automated on-site merchant coupon providing a discount on the purchase of a television and DVD player set may be generated that is not part of the regular coupons or discounts available to a user. Alternatively, the system may determine that the merchant has set up a rule that a specific product is to be price matched against other merchants (either online or in a similar geographically location or via any other criteria) and then generate a coupon providing a discount to the user that allows the user to purchase the product at a lower price or the lowest price based on the prices of the other merchants. In other words, the system may perform price matching for the user and then provide the necessary coupon for the cashier to implement this discount at the cash register. The coupon module 208 may also generate this coupon.

While it can also be performed by the coupon module 208, the display module 202 may generate the images or screens that are to be displayed on the user device when the merchant coupon is transmitted to the user communication device 106. In other words, the display module provides the display content and may also provide the display design for the automated on-site merchant coupon. This may be implemented based on rules set out by the merchant or the system. As outlined above, although the modules are shown as distinct modules in FIG. 2, it will be understood that the functionality of each of the modules may be combined such there may be any number of modules.

The location module 210 may operate to determine the location of the user communication device, preferably via signals from the user communication device. The determination of the user location may allow the system to know where, with respect to the merchant storefront, the user is located. For example, the department in which the user is located or browsing around. In another example, the determination of the user's location may also assist the system in determining what merchants are located geographically close to the merchant storefront such that this information may be used to generate a coupons, such as a price-matching coupon, if needed. In other words, if an on-site merchant price-matching coupon is to be generated based on geographically close merchants, the location of the user may be needed for this determination. In one embodiment, the system may be implemented for a single merchant storefront, however, in another embodiment, the system may be implemented over different storefronts and therefore, the location module can assist to determine the merchant associated with the storefront where the user or user device is located. In one embodiment, the location module, may communicate, either directly with the user communication device or to retrieve location information, such as, but not limited to, global positioning system (GPS) information from the user communication device. In another embodiment, the location module 210 may retrieve other location information from the user device, such as via a check-in on a social media page.

The comparison module 212 may be used to compare the prices between the merchant storefront and other merchants selling the product of interest. If it is determined that a coupon is to be generated for a product (such as based on a determination of the rules implemented by the merchant), the comparison module 212 may search for prices for the product at competing merchants (either geographically, online or based on other criteria) and determine the price difference between the merchant and the lowest located or determined price. If it is determined that the price is lower at another merchant, the comparison module 212 may communicate this to the coupon module 208, or the processor 200, to generate an automated on-site merchant coupon that offers the user a comparable price for the product of interest with respect to the lowest determined price.

The server may also include a barcode module 216 for handling the scanning of barcodes or receiving of scanned barcode information relating to a product of interest to retrieve product of interest information. This product of interest information may then be transmitted to the search module 206 to determine if an automated on-site merchant coupon should be generated (such as discussed above). In another embodiment, the product of interest information received via the barcode scanning may include the price of the product as well at the merchant storefront.

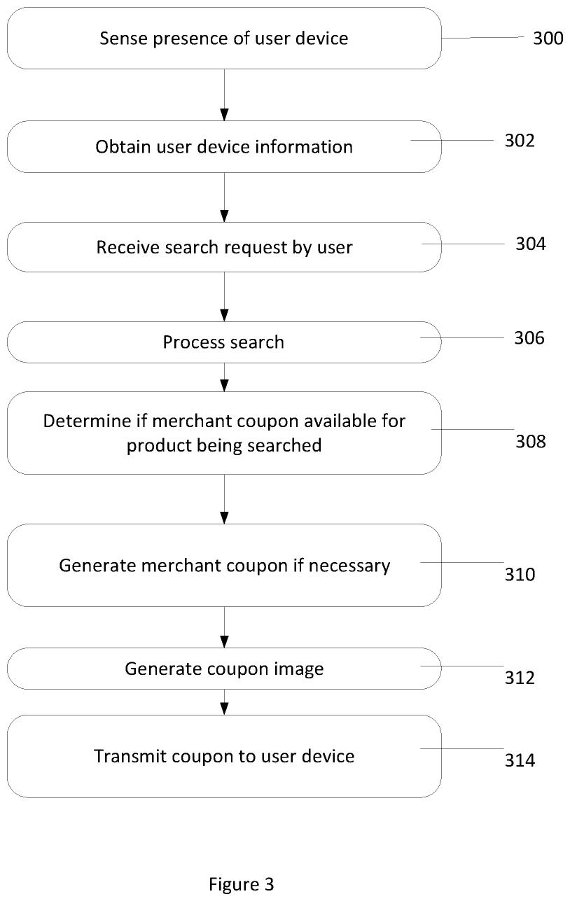

Turning to FIG. 3, a flowchart outlining one embodiment of a method for providing an automated on-site merchant coupon is shown. In the preferred embodiment, the automated on-site merchant coupon is based on a specific product that the user is looking for or at in a store or merchant storefront.

Initially, when a user enters a storefront, or merchant store, the user's presence or location may be sensed by the system (300). In one embodiment, this may be performed by transmitting a message or signal, from the server 102, such as via the communication module 304 and/or the location module 210, to the user communication device 106. A response to the message, or signal, that is received by the system from the user communication device may allow the system to sense or determine that the user has entered the merchant store and, possibly, the user's location within the store. In another embodiment, the server may “ping” the user communication device. In another embodiment, the server may transmit a welcome message and when the user clicks the message or closes the message, a signal is transmitted to the server indicating that the message has been opened thereby confirming a user's presence in the storefront.

The system may then obtain user device information from the user communication device (302). In one embodiment, this may be performed by transmitting a request to the user device for device information. Alternatively, the server 102 may retrieve the information directly from the user communication device. In some embodiments, consent of the user may be required, while in other situations, the information may be automatically retrieved by the server 102. The device information can be used by the server 102 to transmit messages and/or the automated on-site merchant coupon to the correct user device and suitable format based on the type of communication device. The device information may also be used by the server to legally monitor the user's interaction with the user device.

As the user is walking through the storefront, the user may choose to do a search on a product or interest within the store. In another embodiment, the user may scan a barcode associated with a product of interest. Alternatively, the server may sense the location of the user device within the merchant store and by comparing the user's location with a merchant store map may determine the department the user is located. If the user is stationary for more than a predetermined time frame, such as a minute, the server may assume that the user is interested in the product that is proximate the user location as determined by the server. The assumption provides a product of interest for the server to determine if there is an on-site merchant coupon available for the determined product of interest. In this embodiment, the automated on-site merchant coupon may be a general coupon for a discount on electronics rather than a specific product of interest coupon.

If the user is performing a search on a product of interest, the search may be a general search using keywords or may be initiated by scanning a barcode associated with a product that the user is interested in. In both situations, product of interest information is generated by the user communication device. The product of interest information is then received from the user or retrieved from the user communication device where it is received by the processor, such as via the communication module (304) and then processed (306), such as by the search module. In one embodiment of processing, the search module may determine if the product of interest is within a list of products in which an on-site coupon is available. In another embodiment, the search module may transmit a signal or instruction to the coupon module to determine if there is an on-site merchant coupon available for the product of interest based on predetermined rules implemented or designated by the merchant. In another embodiment, the search module may transmit a signal to the coupon module after it has checked for the product of interest against the list of products. In another embodiment, the product of interest information may be processed based on predetermined rules. The system, such as via the coupon module, then determines (308) the type of coupon available. In other words, after determining that there is a coupon available for the product of interest, the system may then determine if there is a deal, or coupon, available for the product of interest. The deal may be implemented via a set of rules.

In one embodiment, the coupon module may determine if a coupon is to be generated by checking a look-up table to see if there is a rule, or coupon, assigned to the product of interest. For instance, the rule may be that there is no coupon available. Alternatively, the rule may be to determine the cheapest price for the selected product, or product of interest, from selected, or predetermined, merchants and to provide an on-site merchant coupon allowing the user to purchase the product at the current merchant location for the lowest selling price from the selected, or predetermined, merchants. In other words, the system provides price matching for the user in the form of an automated on-site merchant coupon. In another embodiment, the coupon may have restrictions such as, but not limited to, the coupon has to be used within or expires in a predetermined time frame, such as 2 hours from generation; the coupon is invalid if the user has left the store (based on GPS tracking), or that the coupon is not valid at other merchants etc.

If a coupon is available, the coupon module, or one of the other modules, generates the on-site merchant coupon (310). This may be performed as suggested above. The generation of the coupon includes the generation of a coupon image (312). The finished coupon is then transmitted to the user communication device (314). The user can then use this coupon if they decide to purchase the product of interest. As such, the user can be provided an automated on-site merchant coupon.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure.

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding. For example, specific details are not provided as to whether elements of the embodiments described herein are implemented as a software routine, hardware circuit, firmware, or a combination thereof.

Embodiments of the disclosure or components thereof can be provided as or represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor or controller to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor, controller or other suitable processing device, and can interface with circuitry to perform the described tasks.

What is claimed is:

1. A method for providing an automated on-site merchant coupon comprising:
determining a product of interest;
determining if a coupon is available for the product of interest; and
generating the automated on-site merchant coupon if a coupon is available for the product of interest.

2. The method of claim 1 wherein determining a product of interest comprises:
receiving a search for the product of interest from a user communication device.

3. The method of claim 1 wherein determining a product of interest comprises:
determining a user's location within a merchant store based on a location of a user communication device;
comparing the user's location with a map of the merchant store; and
determining the product of interest based on the user's location.

4. The method of claim 3 wherein determining the product of interest based on the user's location comprises:
determining a department within the merchant store that the user is located based on the map of the merchant store; and
determining the product of interest based on the user's location within the department.

5. The method of claim 1 wherein determining if a coupon is available comprises:
comparing the product of interest with a list of products; and
determining if the product of interest is on the list of products.

6. The method of claim 5 wherein determining if a coupon is available further comprises:
after determining the product of interest is on the list of products, determining, via a set of predetermined rules, if a coupon is available for the product of interest.

7. The method of claim 1 wherein determining if a coupon is available comprises:
comparing a price of the product of interest with prices of competing merchants;
determining if at least one of the prices of competing merchants is less than the price of the product of interest; and
if at least one of the at least one prices of competing merchants is less than the price of the product of interest, determining a coupon is available.

8. The method of claim 7 wherein generating the automated on-site coupon comprises:
generating a price-matching coupon based on the lowest of the at least one prices that is lower than the price of the product of interest.

9. The method of claim 8 further comprising:
transmitting the price-matching coupon as the automated on-site coupon to the user.

10. The method of claim 1 wherein determining a product of interest comprises:
receiving product of interest information from a user communication device.

11. A computer-readable medium having stored thereon computer executable instructions, that, if executed, cause a computer system to:
determine a product of interest;
determine if a coupon is available for the product of interest; and
generate the automated on-site merchant coupon if a coupon is available for the product of interest.

12. The computer readable medium of claim 11 wherein determining a product of interest comprises:
receiving product of interest information from a user device.

13. The computer readable medium of claim 12 further comprising computer readable instructions that, if executed, cause the computer system to:
compare the product of interest with a list of products; and
determine if the product of interest is on the list of products.

14. The computer readable medium of claim 13 further comprising computer readable instructions that, if executed, cause the computer system to:
after determining the product of interest is on the list of products, determine, via a set of predetermined rules, if a deal is available for the product of interest.

15. The computer readable medium of claim 14 further comprising computer readable instructions that, if executed, cause the computer system to:
compare a price of the product of interest with prices of competing merchants;
determine if at least one of the prices of competing merchants is less than the price of the product of interest; and
if at least one of the prices is less than the price of the product of interest, determine a deal is available.

16. The computer readable medium of claim 15 further comprising computer readable instructions that, if executed, cause the computer system to:
generate a coupon for the user.

17. The computer readable medium of claim 16 further comprising computer readable instructions that, if executed, cause the computer system to:
generate the coupon based on predetermined rules.

18. The computer readable medium of claim 17 further comprising computer readable instructions that, if executed, cause the computer system to:
generate the coupon based on a lower of the at least one of the prices that is less than the price of the product of interest.
